(19) United States
(12) Patent Application Publication
(10) Pub. No.: US 2003/0051005 A1
(43) Pub. Date: Mar. 13, 2003

(54) Apparatus for encapsulating data within a self-defining file and method thereof

(76) Inventors: Charles Carroll Burch JR., Sandia Park, NM (US); William Meredith Menger, Houston, TX (US); Donna Kay Vunderink, Burbank, OK (US); Thomas R. Stoeckley, Ponca City, OK (US); Maximillian McCalla Burton, Ponca City, OK (US); Karen Pauline Goodger, Ponca City, OK (US); James E. Williams, Ponca City, OK (US); Charles Ivan Burch, Ponca City, OK (US)

Correspondence Address: CHERYL S. RATCLIFFE, CONOCO INC., P.O. BOX 4783, HOUSTON, TX, 77210-4783, US

(21) Appl. No.: 09/951,185

(22) Filed: Sep. 13, 2001

(51) Int. Cl. G06F 15/16

(52) U.S. Cl. 709/219; 709/247

(57) ABSTRACT

An apparatus for restructuring data includes a receiving section for receiving a data record having a header and an array, and a compressing section for compressing the header according to a lossless form of compression and for compressing the array according to a lossy form of compression. Also provided is a method for storing the compressed header and the compressed array in a self-defining file. The self-defining file includes a multi-level index, which contains information such as the size and location of compressed headers and compressed arrays contained within the file.

### FIELD OF THE INVENTION

In general, the present invention relates to an apparatus for and a method of restructuring data and encapsulating the restructured data in a self-defining file. The present invention is suitable for converting data blocks, each of which includes data and a respective data header, into a self-defining file, which is preferably reduced in size relative to the original size of the data blocks encapsulated therein, and which includes a multi-level index for allowing efficient accessing of the data blocks stored therein.

### BACKGROUND OF THE INVENTION

Information management has long been a key concern in many industries. While some types of information may be industry specific, many challenges involving information management are universal. These challenges often relate to improving the efficiency and organization of large volumes of information. That is, it is desirable to store as much information in as small a space as possible, while keeping the information readily accessible. Over the years, attempts toward meeting these challenges have resulted in several things, from filing cabinets to microfiche to the electronic data storage devices of today.

Electronic data storage devices have themselves evolved significantly, particularly over the past few decades. This evolution has resulted in great reductions in the amount of space required to store a given amount of information. Likewise, improvements and innovations in software for organizing and preparing information for storage have improved significantly as well. Examples of such software include various types of compression software for restructuring data such that it may be stored in a relatively smaller space and recoverable to a desirable degree. It should be noted, however, that in some cases compression may not reduce the size of a computer file, but may leave the size of the computer file unchanged or even increase the size of the computer file. Accordingly, the term compression will be used throughout this document to include an algorithm that results in decreasing, increasing, or leaving unchanged a size of a computer file, data, or the like that is being compressed.

In general, known compression algorithms can be categorized as being either a lossless or a lossy form of compression. A lossless form of compression is one in which the compression is completely reversible. That is to say, a computer file that undergoes a lossless form of compression may be uncompressed so that the original computer file is completely restored. On the other hand, a lossy form of compression is one in which the compression is not completely reversible. In other words, a computer file that undergoes a lossy form of compression may be uncompressed, but at least some portions of the original computer file will be lost due to the lossy compression process. Because of this, lossy compression is undesirable for a number of types of computer files, such as text files that contain ASCII data. If portions of a text file are lost during a lossy compression process, the text file could be rendered unreadable. However, lossy forms of compression usually are capable of compressing a computer file to a much higher degree than lossless forms of compression. For example, lossless compression ratios are often in the range of 2:1 to 8:1, whereas lossy compression ratios may be in a range of 32:1 to over 100:1.

Because the cost of electronic data storage space increases with the amount of data to be stored, it is desirable to reduce the size of a computer file by compressing it in order to keep storage costs to a minimum. Therefore, if minimizing storage requirements is an important concern, lossy forms of compression may seem preferable to lossless forms of compression. In addition, it is not always necessary for some types of computer files to be completely restored. Examples of such file types include images, video, and audio, because very slight imperfections in these types of computer files are not easily detected by a human observer.

Therefore, both lossy and lossless forms of compression have advantages and disadvantages that have to be considered when selecting an appropriate form of compression for a particular type of computer file. The difficulty in selecting an appropriate form of compression can often be compounded, however, in situations where a computer file includes a combination of data types.

### SUMMARY OF THE INVENTION

In view of the shortcomings of the prior art, it is an object of the present invention to provide an apparatus for, and a process of, efficiently compressing and storing computer files that include mixed data types.

Another object of the present invention is to provide an apparatus for and a process of restructuring a block of data that includes a header, for which a lossy form of compression would not be desirable, and data, for which a lossy form of compression would be acceptable, in such a way that the header is separated from the data, then the header is compressed using a lossless form of compression and the data is compressed using a lossy form of compression, then the thus compressed header and data are recombined and stored.

In order to achieve the desired objects, a method for restructuring data is provided which comprises the steps of receiving a data record, which includes a header and an array; isolating the header and the array from each other; compressing at least one of the header and the array; writing the header and the array to a file; and writing an index that includes a position of the header and the array.

In accordance with another aspect of the present invention, an apparatus for restructuring data is provided which comprises a receiving section for receiving a data record, which includes a header and an array; an isolating section for isolating the header and the array from each other; a memory for storing a file having an index; a compressing section for compressing at least one of the header and the array; a writing section for writing the header and the array to the file; and an updating section for updating the index.

### BRIEF DESCRIPTION OF THE DRAWINGS

The present invention is illustrated by way of example and not limited in the figures of the accompanying drawings, in which like reference numbers indicate similar parts, and in which:

FIG. 1 is a schematic view of a computer network in accordance with an embodiment of the present invention;

FIG. 2 is a schematic block diagram of a flow of data in accordance with an embodiment of the present invention;

FIG. 3 is a flow chart illustrating a process in accordance with an embodiment of the present invention;

FIG. 4 is a flow chart illustrating a sub-process of the process illustrated in FIG. 3;

FIG. 5 is a flow chart illustrating a second sub-process of the process illustrated in FIG. 3; and

FIG. 6 is a schematic view of a file structure in accordance with an embodiment of the present invention.

### DETAILED DESCRIPTION OF THE DRAWINGS

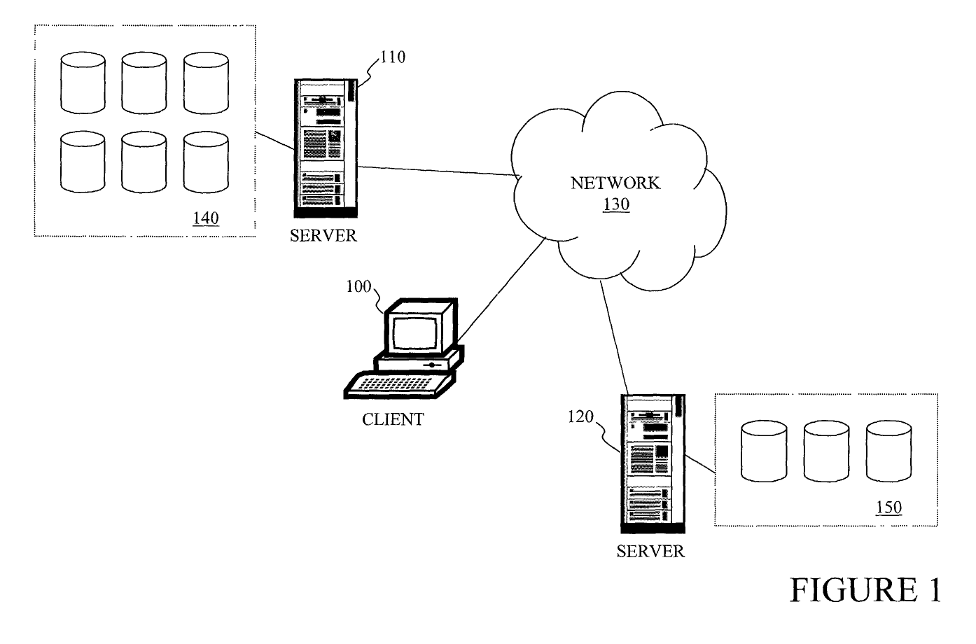

Turning first to FIG. 1, there is shown a schematic view of a computer network in accordance with an embodiment of the present invention. A client computer 100 is provided in communication with a first server computer 110 and a second server computer 120 by way of a network 130. The first server computer 110 is provided in communication with a first data storage device 140. The second server computer 120 is provided in communication with a second data storage device 150. The first and second server computers 110 and 120 are adapted to control the first and second data storage devices 140 and 150, respectively. The client computer 100 is adapted to provide a user interface for allowing a user to access the network 130 and the first and second server computers 110 and 120.

The client computer 100 may be any type of known network client device, such as a dumb terminal, a personal computer, a workstation, or a mobile computer such as a palmtop, laptop, or a personal digital assistant (PDA). The network 130 may be any type of known computer network such as a local area network (LAN), a metropolitan area network (MAN), a wide area network (WAN), a value added network (VAN), an intranet/extranet, the Internet, or any combination thereof. Further, the network 130 may include wired and/or wireless portions. Each of the first and second server computers 110 and 120 may be any type of computer, such as a personal computer, a workstation, a minicomputer, or a mainframe, which is capable of servicing requests from remote clients to read and write files on a respective one of the first and second data storage devices 140 and 150. Each of the first and second data storage devices 140 and 150 may be any one or combination of various known devices, such as hard disk drives, magnetic tape drives, solid state memory devices, and the like. Accordingly, those skilled in the art will recognize that there are numerous variations that may be made to the configuration illustrated in FIG. 1 without departing from the scope of the present invention. For example, a suitable configuration may include any number of computers, server computers, and data storage devices. Further, the data storage device(s) may be local to any one of or any combination of the computers and server computers.

In the illustrated embodiment, a user at the client computer 100 may create a self-defining file for encapsulating or archiving data in accordance with a process of the present invention. The various steps of the process of the present invention may be processed on one or more of the client computer 100, the first server computer 110, or the second server computer 120. The instruction set may be in the form of an application programming interface (API) and a library of functions accessible through the API.

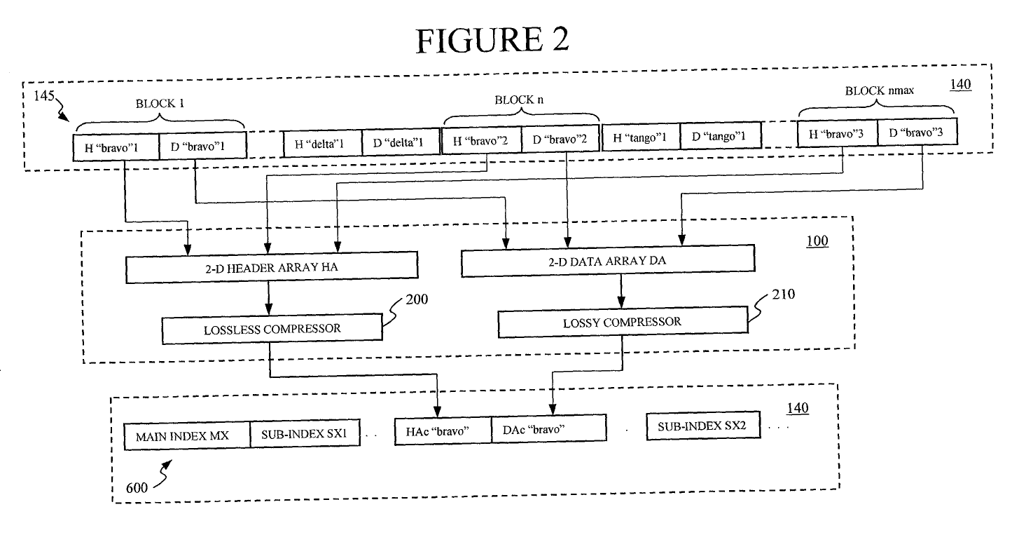

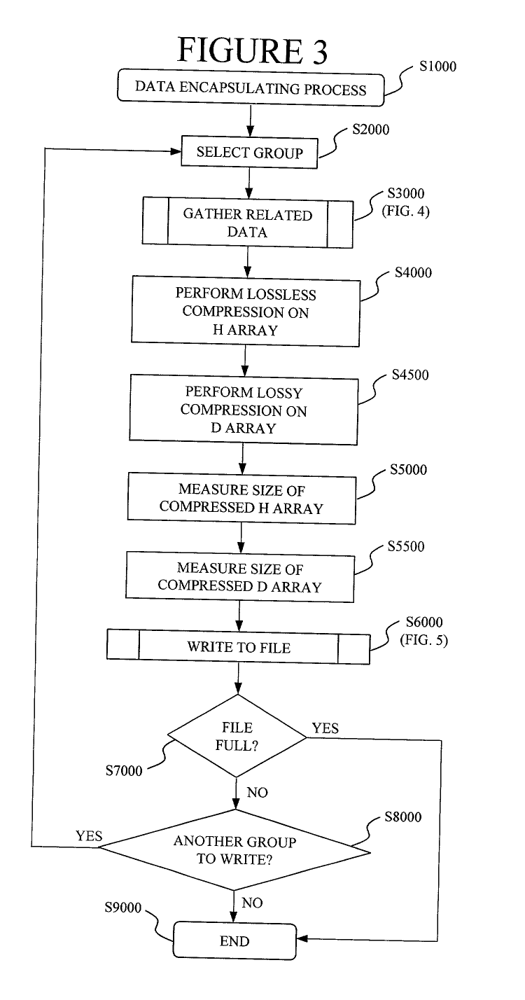

A process for encapsulating data into a self-defining file will now be discussed with reference to the schematic block diagram shown in FIG. 2 and the flowcharts shown in FIGS. 3-5.

As shown in FIG. 2, the first data storage device 140 may include a magnetic tape 145 for storing blocks of seismic trace data, each of which includes a header Hn and a single vector of numbers Dn, i.e. a one-dimensional array, containing actual seismic data. The header Hn may serve to provide a human-readable summary of the respective seismic data, while the seismic data Dn is a string of numerical information that is typically analyzed by various complex processes for purposes such as mapping underlying layers of earth. The blocks of seismic trace data may be arranged or tagged in some way to identify a group to which each respective block belongs. In the illustrated embodiment of FIG. 2, each block has been tagged with a keyword such as “bravo,” “delta,” or “tango” to identify the blocks as belonging to a respective one of a “bravo” group, a “delta” group, or a “tango” group. The tag may simply be a keyword included in each header Hn.

The process for encapsulating data into a self-defining file begins at step S1000 of the flowchart shown in FIG. 3. In step S2000, a group is selected for encapsulating. The group may be selected by a user at the client computer 100, or the group may be selected by a separate process, such as an automated archiving process running on a computer. In the example shown in FIG. 2, the “bravo” group is selected. Once a group has been selected, the process proceeds to step S3000, wherein blocks of data related to the selected group are gathered.

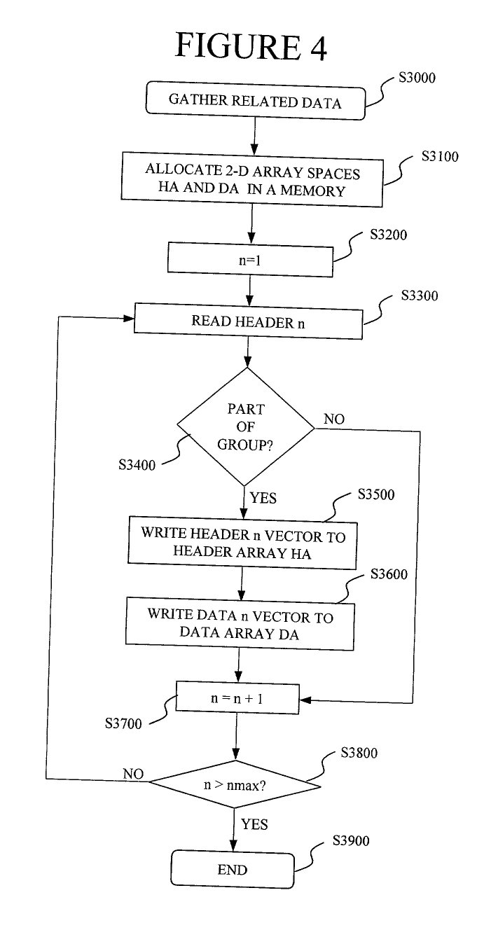

An example of a suitable gathering process S3000 is illustrated in the flowchart shown in FIG. 4. In step S3100, space is allocated in a memory for a two-dimensional header array HA and a two-dimensional data array DA. In the illustrated embodiment of FIG. 2, the memory in which this space is allocated is a buffer included in the client computer 100. However, it is not intended that the location of the memory be limited to the client computer 100. Rather, the memory of the first server computer 110 or the second server computer 120 may be equally suitable for this use. In addition, as one skilled in the art can appreciate, the amount of space allocated may be a fixed or a variable amount.

Next, in step S3200, a counter n is initialized for keeping track of a number of blocks that have been evaluated. In the example illustrated in FIG. 2, blocks of data are being gathered from the magnetic tape 145. In this process, blocks will continue to be evaluated until n=nmax, wherein nmax may be the total number of blocks on the magnetic tape 145. Alternatively, nmax may be any number. Then, in step S3300, the header of block n is read or otherwise evaluated to make a determination as to which group the block n belongs. In step S3400, if the block belongs to the group selected previously at step S2000, the process will continue to step S3500. Otherwise, the process will skip to step S3700 where the counter n is incremented.

If the determination was made at step S3400 that the block belongs to the group selected at step S2000, then steps S3500 and S3600 are performed. In step S3500, the header Hn is added to the two-dimensional header array HA created in step S3100. Then, in step S3600, the data portion Dn of block n is added to the two-dimensional data array DA created in step S3100.

After the counter n is incremented in step S3700, a determination is made at step S3800 as to whether the value of the counter n has exceeded the total number of blocks to be evaluated nmax. If the value of the counter n has exceeded the total number of blocks to be evaluated nmax, then all of the blocks of interest have been evaluated and the gathering process ends at step S3900. Otherwise, steps S3300 through S3800 are performed until all of the blocks of interest have been evaluated.

Once the gathering process S3000 has ended at step S3900, the two-dimensional header array HA will contain the headers H from each of the blocks of the selected group, and the two-dimensional data array DA will contain the data from each of the blocks of the selected group. At this point, the process illustrated in the flowchart shown in FIG. 3 proceeds to step S4000, wherein the two-dimensional header array HA is subjected to a lossless compression algorithm to create a compressed header array HAc. In the example shown in FIG. 2, the lossless compression is performed by the lossless compressor 200. The lossless compression algorithm may be any type of compression wherein data can be uncompressed exactly as it was before compression, i.e. the compression is reversible. Examples of suitable lossless compression algorithms include the ZIP algorithm and lzw coding. Further, a suitable lossless compression algorithm may be one in which the size of the output HAc of the lossless compressor 200 is less than, the same, or greater than the size of the input HA to the lossless compressor 200. At step S4500, the two-dimensional data array DA is subjected to a lossy compression algorithm to create a compressed data array DAc. In the example shown in FIG. 2, the lossy compression is performed by the lossy compressor 210. The lossy compression algorithm may be any type of compression wherein some of the information is discarded, i.e. the compression is irreversible. Examples of suitable lossy compression algorithms include wavelet and jpeg compression.

Thus, in the present embodiment, the two-dimensional header array HA is compressed in such a way that the compression may be reversed, and all of the original header information may be recovered with all of its original content. On the other hand, the two-dimensional data array DA is compressed in such a way that some original data is permanently lost. The reason for compressing the two-dimensional header array HA and the two-dimensional data array DA differently in this way is to strike a balance between a desirable amount of compression and a desirable amount of recoverability. In many industries, such as the banking, medical, finance, insurance, retail and distribution, oil and gas, government, and military industries, there is a requirement for an extremely large amount of space for data storage. For instance, in the oil and gas industry, seismic data used for exploration often spans several hundred gigabytes. Since such a large amount of storage space is expensive, it would be desirable to use a lossy form of compression to compress the seismic data files as much as possible. However, lossy forms of compression may not readily be used in such a situation because it is necessary to keep the header portion of the seismic data files intact and readable. On the other hand, using a lossless form of compression would result in sacrificing storage space that could otherwise be saved. Therefore, if only the header information is considered, it is desirable to be able to compress the information without any loss. Conversely, if only the seismic data is considered, it is acceptable to lose some of the data during compression because analysis or data viewing techniques may not require all of the data in order to obtain acceptable results. Therefore, in accordance with the present invention, a process is provided for achieving a desirable degree of compression without loosing critical information. In the present embodiment, the header is separated from the data and each of the header and the data is compressed according to a respective desirable result.

It is to be noted that the selection of a two-dimensional array rather than an array of some other number of dimensions is based on the input requirements of many known compression algorithms. Therefore, one skilled in the art will appreciate that the number of dimensions of the arrays created before compression may be varied to comply with input requirements of a selected compression algorithm.

Once the steps S4000 and S4500 of compressing the header array HA and the data array DA have been completed, the data encapsulating process continues with step S5000 wherein the size of the compressed header array HAc is measured. Similarly, in the next step S5500, the size of the compressed data array DAc is measured. Determining the size of the compressed header and data arrays HAc and DAc may be accomplished by any one of several known techniques. In some cases, the size of the compressed header and/or data array(s) may be output from the respective compressors 200 and/or 210, so that the step of measuring the size of an array is accomplished by receiving the respective output.

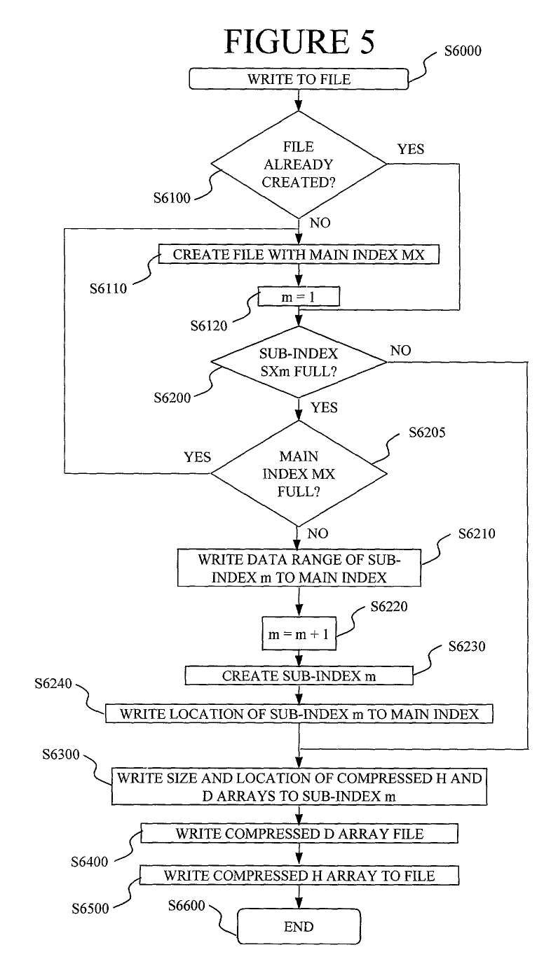

Next, information is written to a self-defining file at step S6000, which is shown in greater detail in the flowchart illustrated in FIG. 5. At step S6100, a determination is made as to whether or not the self-defining file has been created. If the self-defining file has already been created, the steps S6110 and S6120 are skipped. Otherwise, at step S6110 the self-defining file is created in a memory, which may, for example, be located in the second data storage device 150. However, the self-defining file may be created anywhere.

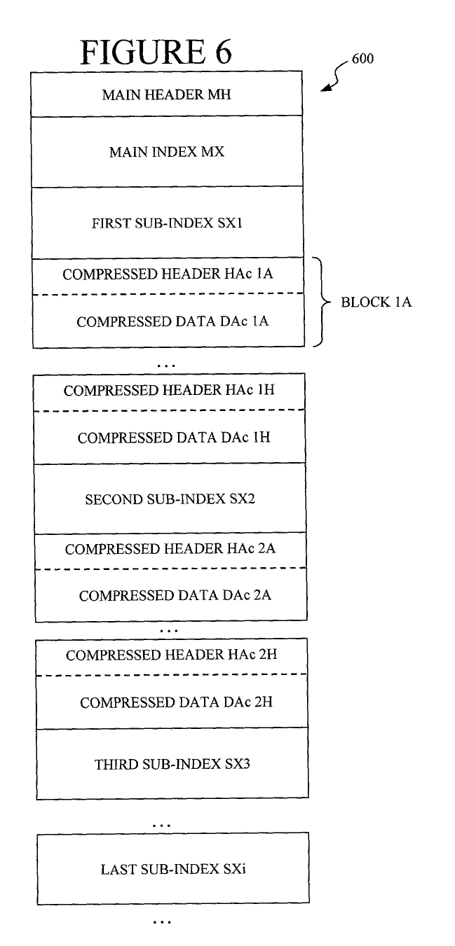

An example of a structure of a self-defining file 600 in accordance with the present invention is shown schematically in FIG. 6. The self-defining file 600 may be written in a mark-up language format similar to the well-known XML format, wherein each section of the file is set off with tags. In the example illustrated, the self-defining file 600 includes a main header MH, which may be identified in the file by a header tag similar to that of an XML structure. The main header MH contains a prolog that defines the contents of the self-defining file 600. It is desirable for the main header MH to include human-readable, formatted, unformatted, binary or ASCII data.

Unlike a conventional XML file, the self-defining file 600 of the present invention includes an indexing system, which preferably may be read by a human or a computer, for providing information about the specific location of the starting and ending positions of various portions of the self-defining file 600. In the example shown in FIG. 6, the self-defining file 600 includes a two-tiered indexing system comprising a main index MX, and a plurality of sub-indexes SX1-SXi, wherein i is the total number of sub-indexes. The main index MX includes information about the specific location of the starting and ending positions of each of the sub-indexes SX1-SXi, as well as information about the contents indexed by each of the sub-indexes SX1-SXi. Each of the sub-indexes SX1-SXi includes information about the specific starting and ending positions of each of a plurality of blocks following the respective sub-index. Again referring to the example shown in FIG. 6, the first sub-index SX1 includes information about the starting and ending positions of blocks 1A-1H. Each of the blocks 1A-1H preferably includes a unique identifier, such as a tag, for providing a unique reference by which each of the blocks 1A-1H may be indexed. For instance, in the example illustrated in FIG. 2, the group name “bravo” is used as a tag for the block being added to the self-defining file 600.

Naturally, the self-defining file 600 may be structured in some alternative way without departing from the spirit and scope of the present invention. For instance, the self-defining file 600 may be created without an indexing system using a known XML format. In this case, the self-defining file would include a header followed by tagged blocks of compressed header arrays HAc and compressed data arrays DAc. However, when a self-defining file created using an XML format is to be read, it is processed by a parser. For example, if it is desired to extract all blocks having a particular tag, the parser will need to read the entire file in order to find each data block designated with the particular tag. In some cases, depending on the size of the self-defining file, the time required for the entire file to be searched may be acceptable.

However, in some cases the blocks contained within the self-defining file may be large, and consequently the self-defining file is large, as is often the case with seismic data. In this case, it often takes an undesirably long period of time for a parser to read the entire self-defining file searching for a block having a particular tag. Therefore, the self-defining file 600 of the present invention has been provided with an indexing system so that a parser adapted to read a file having an indexed format does not have to search the entire file to find a desired block. Instead, as in the example shown in FIG. 6, if a block having a particular tag, such as “bravo” is being searched for by a parser, the parser would read the main index MX. The main index MX would direct the parser to the location of sub-index SX2, which includes information about the “bravo” block. The parser could then skip directly to sub-index SX2, which would in turn direct the parser to the location of the “bravo” block 2A. This way, the parser could skip directly to the block 2A tagged “bravo.” If the self-defining file 600 included multiple blocks tagged “bravo,” the indexing system could direct the parser to each of the multiple locations. Therefore, desired blocks of data may be directly accessed using the indexing system, thereby eliminating a significant amount of time that would otherwise be necessary for the entire self-defining file 600 to be read.

Turning back now to the process illustrated in the flowchart shown in FIG. 5, the step S6110 of creating a file with a main index may be carried out by creating a file having a main header MH, a main index MX, and a first sub-index SX1 set off by appropriate tags. The starting position of the first sub-index SX1 can also be written to the main index MX at this time. The reason for this is that the size of the main index MX will be predetermined to limit the size of the main index MX and prevent it from becoming extraordinarily large. Therefore, the starting location of the first sub-index SX1 may easily be deduced. Then, at step S6120 a counter variable m is initialized to 1. The counter variable m will be used to keep track of a current sub-index SXm.

At step S6200, it is determined if the current sub-index SXm is full. It is desirable to place a limit on the size of each sub-index SX1-SXi, just as a limit is placed on the size of the main index MX. If the main index MX or the sub-indexes SX1-SXi are allowed to become too large, then it would take an undesirably long amount of time for the parser to read the indexes. Therefore, the exact size limit placed on the main index MX and the sub-indexes SX1-SXi may selected based on several factors, such as those associated with the processing speed of a parser to be used for reading the self-defining file 600.

If, at step S6200, it is determined that the current sub-index SXm is full, then the process continues to step S6205. Otherwise, the process skips to step S6300. Step S6205 checks to see if the main index MX has reached its size limit. If so, the process proceeds to step S6110 to create a new file. Alternately, the user could be flagged and given an option to create a new file or end the process. If, at step S6205, it is determined that the main index has not reached its size limit, the process proceeds to step S6210.

At step S6210, main index MX is updated with the range of data indexed by subindex SXm. In the present example, this would include adding a list of groups to the main index MX that are indexed by the sub-index SXm. Then, at step S6220, the counter variable m is incremented by one, and at step S6230 a new sub-index SXm is created. The new sub-index SXm may be located immediately following the end of the blocks indexed by sub-index SXm-1. Then the location of the new sub-index SXm is added to the main index MX at step S6240. The step S6240 may optionally include adding the location of the end of the blocks of data indexed by sub-index SXm-1.

Next, at step S6300, the sub-index SXm is updated with information about the compressed header array HA and the compressed data array DA that were most recently compressed at steps S4000 and S4500. The information added to the sub-index SXm preferably includes the size of the compressed header and data arrays HA and DA, which was determined at steps S5000 and S5500. The information added to the sub-index SXm preferably also includes the location at which a new block containing the compressed header and data arrays HA and DA will be written. Finally, it is preferable to include the identifying tag for the new block (“bravo” in the example shown in FIG. 2) in the information added to the sub-index SXm. Then, once the sub-index SXm has been updated, the process proceeds to step S6400 wherein the compressed header array HA is written to the self-defining file 600, and then to step S6500 wherein the compressed data array DA is written to the self-defining file 600. The step S6000 of writing to the self-defining file then ends at step S6600, and the process proceeds to step S7000 shown in the flowchart illustrated on FIG. 3.

As mentioned above, the size of the main index MX is preferably limited to ensure that a parser may be capable of reading the main index MX in an acceptable amount of time. It may be additionally desirable to place a limit on the size of the self-defining file 600. Therefore, at step S7000, a check is made to determine if the self-defining file 600 has reached or exceeded its size limit. If so, the process skips to step S9000 where the data encapsulating process is terminated. Optionally, at step S7000, the user may be given an option to either create a new file or end the process. If, at step S7000, it is determined that the self-defining file 600 has not reached or exceeded its predetermined size limit, the process proceeds to step S8000. At step S8000 a determination is made as to whether there is another group to encapsulate into the self-defining file 600. This determination may be made by querying the user, or it may be made by a separate process, such as the automated archiving process mentioned above. If, at step S8000, it is determined that there are one or more additional groups to encapsulate, the process proceeds to step S2000 previously described. Otherwise, if there are no additional groups to encapsulate, the data encapsulating process ends at step S9000.

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the claims. For example, the embodiment of the invention has been described above as being carried out in a computer network environment. However, as one skilled in the art will appreciate, alternative embodiments of the present invention may include only local devices, such as a local hard drive, disk drive, or processor. Naturally, alternative embodiments of the present invention may also include a combination of local and networked devices.

Furthermore, it is not intended that the present invention be limited to any particular number of data storage devices. In fact, alternative embodiments of the present invention may gather blocks from and create the self-defining file on a same data storage device. In such a case, the self-defining file may be written to a location that is different than the location of the original blocks of data, or the original blocks of data may be at least partially overwritten by the self-defining file.

In a still further embodiment of the present invention, the compressors 200 and 210 may be replaced with any type of restructuring section, and accordingly, the steps S4000 and S4500 may be for performing a respective type of data restructuring. For instance, both of the compressors 200 and 210 (and the steps S400 and S4500) may be for performing lossy compression, or both of the compressors 200 and 210 (and the steps S400 and S4500) may be for performing lossless compression. One of these two types of arrangements may be desirable in a situation wherein, for example, lossy compression is desirable for both arrays, but a first lossy compression algorithm is better suited for a first of the two arrays while a second lossy compression algorithm is better suited for a second of the two arrays.

What is claimed is:

1. A method for restructuring data, comprising the steps of:
receiving a data record, which includes a header and an array;
isolating the header and the array from each other;
compressing at least one of the header and the array;
writing the header and the array to a file; and
writing an index associated with the file that includes a location of the thus written header and array.

2. A method in accordance with claim 1, wherein the step of compressing includes compressing the header.

3. A method in accordance with claim 2, wherein the step of writing the header and the array is performed after the step of compressing, so that the header is compressed when written to the file.

4. A method in accordance with claim 2, wherein the header is compressed using a lossless form of compression.

5. A method in accordance with claim 1, wherein the step of compressing includes compressing the array.

6. A method in accordance with claim 5, wherein the step of writing the header and the array is performed after the step of compressing, so that the array is compressed when written to the file.

7. A method in accordance with claim 5, wherein the array is compressed using a lossy form of compression.

8. A method in accordance with claim 1, wherein the step of compressing includes compressing both the header and the array.

9. A method in accordance with claim 8, wherein the step of writing the header and the array is performed after the step of compressing, so that the header and the array are both compressed when written to the file.

10. A method in accordance with claim 8, wherein the header is compressed using a first compression algorithm, and wherein the array is compressed using a second compression algorithm, the first compression algorithm being different from the second compression algorithm.

11. A method in accordance with claim 10, wherein the first compression algorithm is a lossless form of compression, and wherein the second compression algorithm is a lossy form of compression.

12. A method in accordance with claim 1, wherein the file includes a main index, and the index written in the step of writing an index is a sub-index of the main index.

13. A method in accordance with claim 12, further comprising the step of writing a starting location of the sub-index to the main index.

14. A method in accordance with claim 13, further comprising the step of writing information associated with the header and the array to the sub-index.

15. A method in accordance with claim 14, further comprising the step of writing the information associated with the header and the array to the main index.

16. An apparatus for restructuring data comprising:
a receiving section for receiving a data record, which includes a header and an array;
an isolating section for isolating the header and the array from each other;
a memory for storing a file having an index;
a compressing section for compressing at least one of the header and the array;
a writing section for writing the header and the array to the file; and
an updating section for updating the index.

17. An apparatus in accordance with claim 16, wherein the compressing section is for compressing the header.

18. An apparatus in accordance with claim 17, wherein the writing section writes the header after the compressing section compresses the header, so that the header is compressed when written to the file.

19. An apparatus in accordance with claim 17, wherein the compressing section is a lossless compressor.

20. An apparatus in accordance with claim 16, wherein the compressing section is for compressing the array.

21. An apparatus in accordance with claim 20, wherein the writing section writes the array after the compressing section compresses the array, so that the array is compressed when written to the file.

22. An apparatus in accordance with claim 20, wherein the compressing section is a lossy compressor.

23. An apparatus in accordance with claim 16, wherein the compressing section is for compressing both of the header and the array.

24. An apparatus in accordance with claim 23, wherein the writing section writes the header and the array after the compressing section compresses both of the header and the array, so that the header and the array are both compressed when written to the file.

25. An apparatus in accordance with claim 23, wherein the compressing section comprises a first compressor for compressing the header and a second compressor for compressing the array, wherein the first compressor is different than the second compressor.

26. An apparatus in accordance with claim 25, wherein the first compressor performs a lossless form of compression and the second compressor performs a lossy form of compression.

27. An apparatus in accordance with claim 16, wherein the updating section writes a location of the thus written header and array to the index.

28. An apparatus in accordance with claim 16, wherein the file includes a main index, and the index is a sub-index of the main index.

29. An apparatus in accordance with claim 28, wherein the updating section writes a starting location of the sub-index to the main index.

30. An apparatus in accordance with claim 29, wherein the updating section writes information associated with the header and the array to the sub-index.

31. An apparatus in accordance with claim 30, wherein the updating section writes the information associated with the header and the array to the main index.

32. A computer program comprising:
instructions for receiving a data record, which includes a header and an array;
instructions for isolating the header and the array from each other;
instructions for compressing at least one of the header and the array;
instructions for writing the header and the array to a file; and
instructions for writing an index associated with the file that includes a location of the thus written header and array.

33. A computer program in accordance with claim 32, wherein the instructions for compressing are for compressing the header.

34. A computer program in accordance with claim 33, wherein the instructions for writing the header and the array are for writing the header after the compressing of the header, so that the header is compressed when written to the file.

35. A computer program in accordance with claim 33, wherein the instructions for compressing are for performing a lossless form of compression on the header.

36. A computer program in accordance with claim 32, wherein the instructions for compressing are for compressing the array.

37. A computer program in accordance with claim 26, wherein the instructions for writing the header and the array are for writing the array after the compressing of the array, so that the array is compressed when written to the file.

38. A computer program in accordance with claim 36, wherein the instructions for compressing are for performing a lossy form of compression on the array.

39. A computer program in accordance with claim 32, wherein the instructions for compressing are for compressing both of the header and the array.

40. A computer program in accordance with claim 39, wherein the instructions for writing the header and the array are for writing the header and the array after the compressing of the header and the array, so that the header and the array are both compressed when written to the file.

41. A computer program in accordance with claim 39, wherein the instructions for compressing are for applying a first compression algorithm to the header and for applying a second compression algorithm to the array, wherein the first compression algorithm is different than the second compression algorithm.

42. A computer program in accordance with claim 41, wherein the first compression algorithm is for a lossless form of compression, and wherein the second compression algorithm is for a lossy form of compression.

43. A computer program in accordance with claim 32, wherein the file includes a main index, and the index written by the instructions for writing an index is a sub-index of the main index.

44. A computer program in accordance with claim 43, further comprising instructions for writing a starting location of the sub-index to the main index.

45. A computer program in accordance with claim 44, further comprising instructions for writing information associated with the header and the array to the sub-index.

46. A computer program in accordance with claim 45, further comprising instructions for writing the information associated with the header and the array to the main index.
